(19) United States
(12) Patent Application Publication
(10) Pub. No.: US 2015/0061562 A1
(43) Pub. Date: Mar. 5, 2015

(54) MOTOR DRIVE UNIT

(71) Applicant: KABUSHIKI KAISHA TOKAI RIKA DENKI SEISAKUSHO, Aichi (JP)

(72) Inventor: Masanori FUJII, Aichi (JP)

(21) Appl. No.: 14/474,888

(22) Filed: Sep. 2, 2014

(30) Foreign Application Priority Data
Sep. 3, 2013 (JP) 2013-182325

(51) Int. Cl. H02H 7/08

(52) U.S. Cl. CPC H02H 7/0844
USPC 318/476; 318/490

(57) ABSTRACT

A motor drive unit includes a motor drive circuit that drives a motor by controlling on/off of current, a control unit generating a drive command signal for driving the motor, a current feedback circuit with the motor and outputs a comparison output signal based on comparison between a current detection signal of a motor current and a target value signal, a latch circuit that latches a current detection result based on the drive command signal and the comparison output signal, and a gate circuit for driving the motor drive circuit based on the drive command signal and a latch output signal output from the latch circuit. The control unit detects a failure of a current feedback system including the current feedback circuit and the latch circuit according to a state of the latch output signal inputted after a time measured based on the drive command signal reaches a predetermined time.

The present application is based on Japanese patent application No. 2013-182325 filed on Sep. 3, 2013, the entire contents of which are incorporated herein by reference.

### BACKGROUND OF THE INVENTION

1. Field of the Invention

The invention relates to a motor drive unit and, in particular, to a motor drive unit that allows the failure detection of a current feedback system without using a separate failure detection circuit.

2. Related Art

A motor drive unit is known that is provided with a motor drive circuit to perform a constant current control of a current flowing through a load of a motor etc. by means of a current feedback system and is provided with an overcurrent detection circuit (see e.g. JP-A-2013-062721).

The motor drive unit has a shunt resistor for detecting a current flowing through the motor as a voltage value and a comparator for comparing the detected voltage with threshold voltage. The threshold voltage is generated by a threshold generation circuit which is configured to increase the threshold voltage with an increase in AC changes of motor current/power supply voltage value and also to increase the threshold voltage with a decrease in temperature of the motor. Thus, desired hysteresis characteristics can be maintained and it is possible to stably detect a failure and to recover from the overcurrent detected state.

### SUMMARY OF THE INVENTION

The conventional motor drive unit is not configured to use a part thereof to detect a failure such as overcurrent and it is thus necessary to use a failure detection circuit separate from the motor drive unit. This may cause an increase in circuit space and the number of components.

It is an object of the invention to provide a motor drive unit that allows the failure detection of the current feedback system by using a part of the motor drive unit without using a separate failure detection circuit.

(1) According to one embodiment of the invention, a motor drive unit comprises:

a motor drive circuit that drives a motor by controlling on/off of current;

a control unit generating a drive command signal for driving the motor;

a current feedback circuit that comprises a current detection resistor and a comparator connected in series with the motor and outputs a comparison output signal based on comparison between a current detection signal of a motor current and a target value signal;

a latch circuit that latches a current detection result based on the drive command signal and the comparison output signal; and

a gate circuit for driving the motor drive circuit based on the drive command signal and a latch output signal output from the latch circuit,

wherein the control unit detects a failure of a current feedback system comprising the current feedback circuit and the latch circuit according to a state of the latch output signal inputted after a time measured based on the drive command signal reaches a predetermined time.

In the above embodiment (1) of the invention, the following modifications and changes can be made.

(i) The predetermined time is set to be a time T2 to reach a target current to be set by the target value signal during normal operation.

(ii) When a failure is detected, the control unit changes the drive command signal to turn off the current flowing though the motor.

(iii) The control unit comprises a single chip microcomputer and

wherein the time measured based on the drive command signal is measured by a timer unit built in the single chip microcomputer.

(iv) The control unit determines a failure when the latch output signal is not inverted after the measured time after the measured time reaches the time T2.

(v) The control unit terminates an operation of the failure detection when the latch output signal is inverted after the measured time after the measured time reaches the time T2.

(vi) The control unit outputs at least once the drive command signal in a motor drive command time T1 greater than the time T2.

### EFFECTS OF THE INVENTION

According to one embodiment of the invention, a motor drive unit can be provided that allows the failure detection of the current feedback system by using a part of the motor drive unit without using a separate failure detection circuit.

### BRIEF DESCRIPTION OF THE DRAWINGS

Next, the present invention will be explained in more detail in conjunction with appended drawings, wherein:

FIG. 1 is a schematic block diagram illustrating a motor drive unit in an embodiment of the present invention;

FIG. 2 is a circuit diagram illustrating the motor drive unit in the embodiment of the invention;

FIG. 3 is a diagram illustrating signal waveforms of respective portions during normal operation of the motor drive unit in the embodiment of the invention;

FIG. 4 is a flowchart showing an operation to detect a failure of a current feedback system in the motor drive unit; and

FIG. 5 is a diagram illustrating signal waveforms of respective portions when a failure occurs in the motor drive unit in the embodiment of the invention.

### DESCRIPTION OF THE PREFERRED EMBODIMENT

Overall Structure of Motor Drive Unit 1

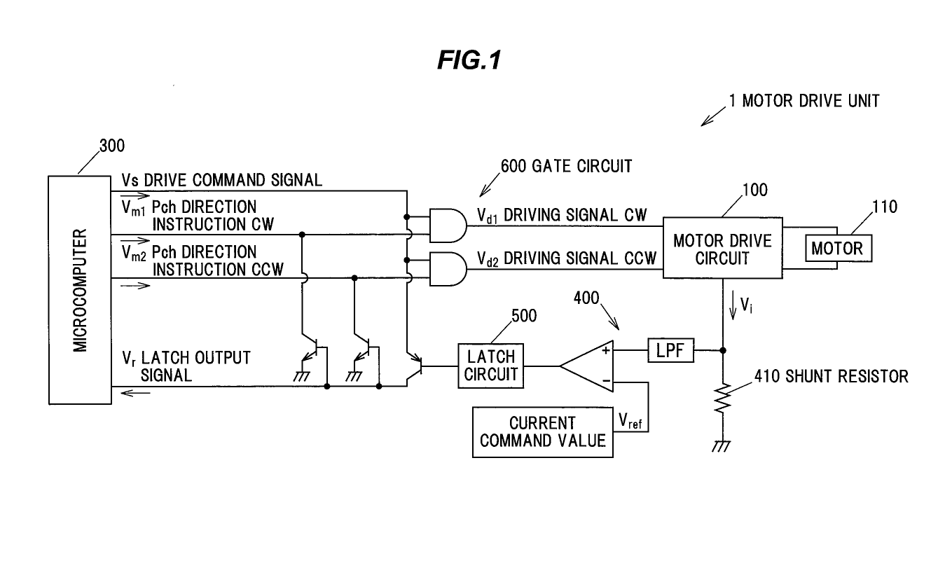

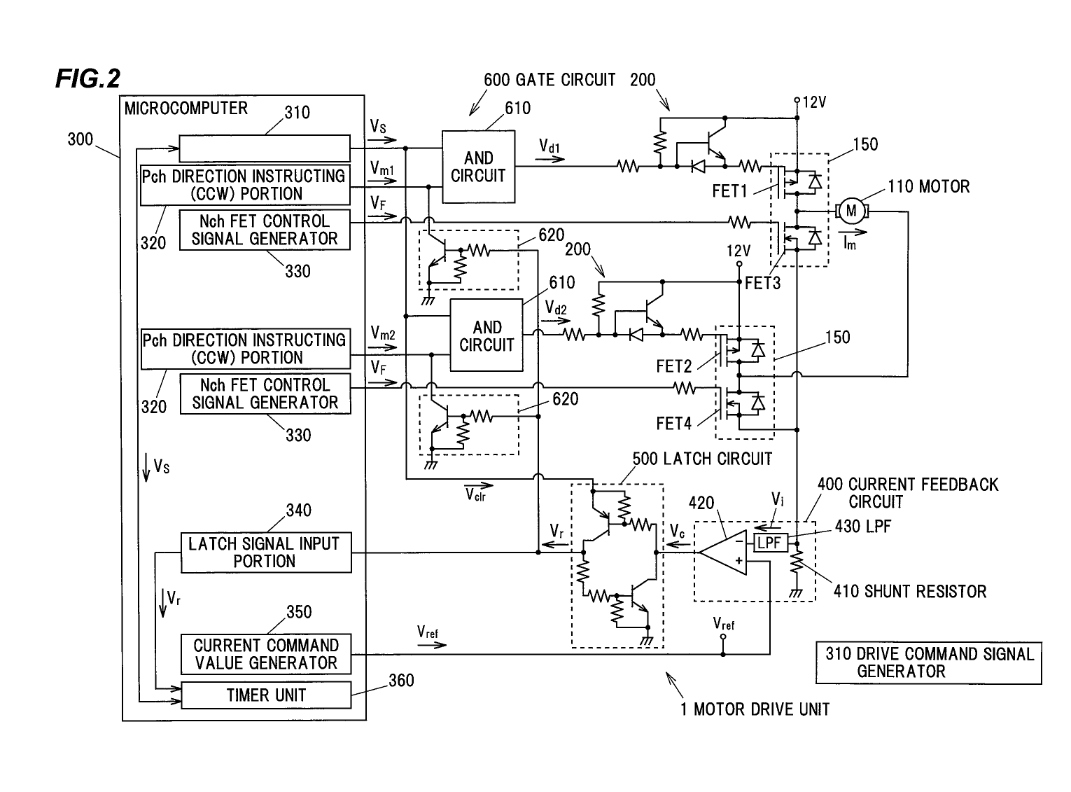

FIG. 1 is a schematic block diagram illustrating a motor drive unit in the embodiment of the invention and FIG. 2 is a circuit diagram illustrating the motor drive unit in the embodiment of the invention.

The motor drive unit 1 in the embodiment of the invention has a motor drive circuit 100 which drives a motor 110 by controlling on/off of current, a microcomputer 300 as a control unit generating a drive command signal Vₛ for driving the motor 110, a current feedback circuit 400 which is composed of a shunt resistor 410 as a current detection resistor and a comparator 420 connected in series with the motor 110 and outputs a comparison output signal V_{c} based on comparison between a current detection signal Vᵢ of a motor current Iₘ and a target value signal V_{ref}, a latch circuit 500 which latches a current detection result based on the drive command signal Vₛ and the comparison output signal V_{c}, and a gate circuit 600 for driving the motor drive circuit 100 based on the drive command signal Vₛ and a latch output signal Vᵣ output from the latch circuit 500.

In this configuration, the motor drive circuit 100 has a bridge circuit 150 controlling on/off of the current Iₘ flowing through the motor 110 and a drive circuit 200 for driving the bridge circuit 150. Meanwhile, the microcomputer 300 is configured to determines the state of the latch output signal Vᵣ on the basis of time measured based on the drive command signal Vₛ and thus to detect a failure of a current feedback system which is composed of the current feedback circuit 400 and the latch circuit 500.

The bridge circuit 150 is composed of four MOSFETs and has a bridge configuration in which the motor 110 is connected between a FET 1 and a FET 3 and between a FET 2 and a FET 4. By turning on the FETs 1 and 4 and turning off the FETs 2 and 3, a motor current flows in a direction of Iₘ shown in FIG. 2 and the motor 110 runs forward. Conversely, by turning off the FETs 1 and 4 and turning on the FETs 2 and 3, the motor current flows in a reverse direction and the motor 110 runs backward. The rotation of the motor 110 is controlled by a combination and timing of ON/OFF of the MOSFETs. Note that, the combination and timing of ON/OFF of the MOSFETs are controlled by predetermined on/off signals input from the drive circuit 200 and the gate circuit 600.

The drive circuit 200 is connected to the gate circuit 600 on the input side and is connected to the bridge circuit 150 on the output side. Switching of each FET is controlled based on driving signals V_{d1} and V_{d2} output from the gate circuit 600 and an electric current then flows from supply voltage 12V to the bridge circuit 150 and the motor 110.

The microcomputer 300 is a single chip microcomputer as a control unit which is provided with a drive command signal generator 310 generating the drive command signal Vₛ for driving the motor 110, Pch direction instruction portions 320, Nch FET control signal generators 330, a latch output signal input portion 340, a current command value generator 350 and a timer unit 360, etc.

The drive command signal generator 310 generates the drive command signal Vₛ as a PWM (Pulse Width Modulation) signal for driving the motor 110. Using, e.g., a PWM function, etc., of the microcomputer 300, the drive command signal Vₛ during motor drive command time T1 is generated by inverting an output between Hi-level and Lo-level at regular intervals. The drive command signal Vₛ as an output is connected to the latch circuit 500 and the gate circuit 600.

The Pch direction instruction portions 320 output motor drive direction control signals Vₘ₁ and Vₘ₂ which are signals for controlling the rotation direction of the motor 110. The motor drive direction control signals Vₘ₁ and Vₘ₂ are input to AND circuits 610 of the gate circuit 600.

The Nch FET control signal generators 330 output Nch FET control signals V_{F1} and V_{F2} which are signals for controlling the rotation direction of the motor 110. Hi or Lo-level of the Nch FET control signals V_{F1} and V_{F2} are input to the FETs 3 and 4 at a predetermined timing to control ON/OFF of the MOSFETs. The bridge circuit 150 is controlled by a combination of the Nch FET control signals V_{F1} and V_{F2} with the motor drive direction control signals Vₘ₁ and Vₘ₂, thereby controlling the rotation direction of the motor 110.

The latch output signal Vᵣ output from the latch circuit 500 is input to the feedback input portion 340. The input latch output signal Vᵣ (=a current feedback signal) is further input to the timer unit 360 in the microcomputer.

The target value signal V_{ref}, which is DC voltage signal to the current feedback circuit 400 and is a reference voltage (threshold) of the comparator 420, is input to the comparator 420 from the current command value generator 350. By adjusting the target value signal V_{ref}, it is possible to control the motor current Iₘ and thereby to adjust a steady rotation speed of the motor.

The timer unit 360 is built in the microcomputer 300. The latch output signal Vᵣ is input to the timer unit 360 which then measures time elapsed from the rise of the drive command signal Vₛ.

The current feedback circuit 400 and the latch circuit 500 described below form the current feedback system from the motor 110 to the microcomputer 300.

The current feedback circuit 400 is composed of the shunt resistor 410 and the comparator 420 which are connected in series with the motor 110. The shunt resistor 410 is connected to the comparator 420 via a low-pass filter (LPF) 430. Thus, unstable operation caused by noise or voltage ripple, etc., is suppressed. The comparison output signal V_{c} is output based on comparison between the current detection signal Vᵢ of the motor current Iₘ and the target value signal V_{ref}. The output of the current feedback circuit 400 is connected as the comparison output signal V_{c} to the input of the latch circuit 500. When, for example, the bridge circuit 150 is driven by turning on the drive circuit 200 and a current flows through the motor 110, the same current (Iₘ) as that flowing through the motor 110 also flows through the shunt resistor 410 which is connected to the motor 110. Due to the motor current Iₘ flowing through a resistor Ra of the shunt resistor 410, the current detection signal Vᵢ (=Ra×Iₘ) is generated at both ends of the shunt resistor 410. The comparator 420 compares the current detection signal Vᵢ with the target value signal V_{ref} generated by the current command value generator 350, the comparison output signal V_{c} is inverted and output when the target value signal V_{ref} becomes less than the current detection signal Vᵢ, and this comparison output signal V_{c} is input to the latch circuit 500.

The latch circuit 500 receives the drive command signal Vₛ from the microcomputer 300 as well as the comparison output signal V_{c} from the current feedback circuit 400, and latches (holds) a current detection result based on the drive command signal Vₛ and the comparison output signal V_{c}. The latch output signal Vᵣ is input to the latch output signal input portion 340 and is also input to the gate circuit 600 via a drive stopping Tr 620.

The gate circuit 600 outputs the driving signals Val and Vat based on the drive command signal Vₛ as well as the latch output signal Vᵣ output from the latch circuit 500. Since the rotation direction of the motor is also controlled in the present embodiment, the AND circuits 610 output the driving signals V_{d1} and V_{d2} as the logical AND of the drive command signal Vₛ and the latch output signal Vᵣ or the motor drive direction control signals Vₘ₁, Vₘ₂. The drive circuit 200 is driven by the driving signals V_{d1} and V_{d2} and the motor 110 is powered on. Then, the rotation direction of the motor is controlled by the Nch FET control signal generators 330 in combination with gate control using the motor drive direction control signals Vₘ₁ and Vₘ₂.

Normal Operation of Motor Drive Unit 1

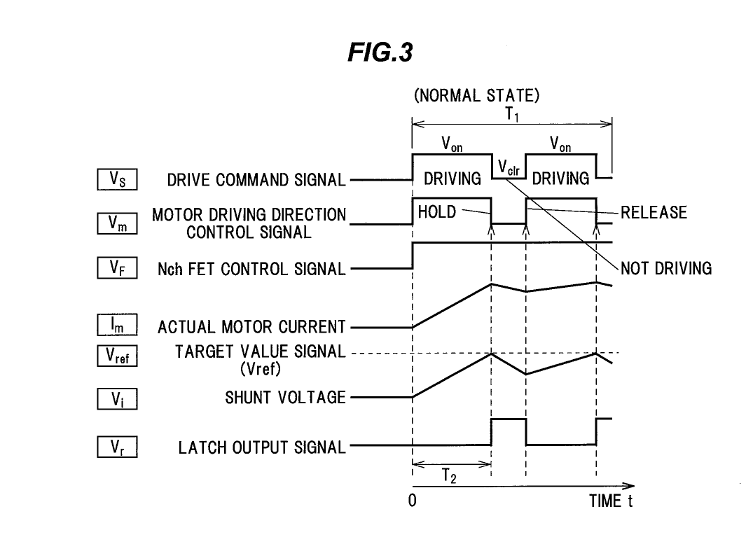

FIG. 3 is a diagram illustrating signal waveforms of respective portions during normal operation of the motor drive unit in the embodiment of the invention. The normal operation (constant-current control operation) of the motor drive unit 1 will be described in order of the following (1) to (9) along the waveforms at main points during normal operation shown in FIG. 3.

(1) In the motor drive command time T1, the output of the drive command signal Vₛ becomes Hi-level (ON signal Vₒₙ).

(2) The driving signals V_{d1} and V_{d2} are output from the gate circuit 600 to turn on the FETs 1 and 4 and off the FETs 2 and 3.

(3) The current Iₘ flows through the motor 110 and the current detection signal Vᵢ is generated by the shunt resistor 410.

(4) The latch output signal Vᵣ becomes Hi-level when the current detection signal Vᵢ becomes more than the target value signal V_{ref}.

(5) Accordingly, the FETs 1 and 4 are turned off, the motor 110 stops running and the current detection signal Vᵢ becomes 0.

(6) After a predetermined period of time, the drive command signal Vₛ is switched to Lo-level (switched from the ON signal Vₒₙ to a latch-clear signal V_{clr}).

(7) At the switching edge of the drive command signal Vₛ from Hi to Lo-level (when switched to the latch-clear signal V_{clr}), the holding state of the latch circuit 500 is released.

(8) The driving signal V_{d} continues staying Lo-level during the Lo-level period of the drive command signal Vₛ (during the latch-clear signal V_{clr} period).

(9) After a predetermined period of time, the drive command signal Vₛ is switched to Hi-level (switched to the ON signal Vₒₙ).

From this onward, the operations of (1) to (9) are repeated in the motor drive command time T1. As shown in FIG. 3, in the periods of (3) and (5), the motor 110 is driven with a constant current at a current value which is determined by the current feedback circuit 400 and corresponds to the target value signal V_{ref}, while an actual motor current repeats increase and decrease.

Operation of Motor Drive Unit 1 in Failure

In FIG. 3, a motor current waveform during operation of the motor exponentially increases according to time constant. That is, when the motor is operated, a current flows through the motor 110 and then gradually increases due to resistance and coil component. The motor current Iₘ is represented by the following formula:

Motor current Iₘ=(supply voltage 12V/armature resistance)×(1−e^{-t}/τe)

where τe is a ratio of inductance to armature resistance. Time T2 to reach the target current set by the target value signal V_{ref} during the operation of the motor is derived from the above formula.

In the present embodiment, when T2, which is derived as a period of time in which the current flows through the motor 110, gradually increases due to the coil component and then reaches the target current (current feedback), satisfies the relation of Motor drive command time T1>T2, T2 is set as current feedback detection time.

That is, when the output of the latch output signal Vᵣ is not inverted after the current feedback detection time T2 is elapsed since the drive command signal Vₛ is output from the microcomputer 300 to drive the motor 110 (during the motor drive command time T1), it is judged that the circuit is malfunctioning (a failure of the current feedback system) and the motor 110 is stopped by switching the drive command signal Vₛ to Lo-level.

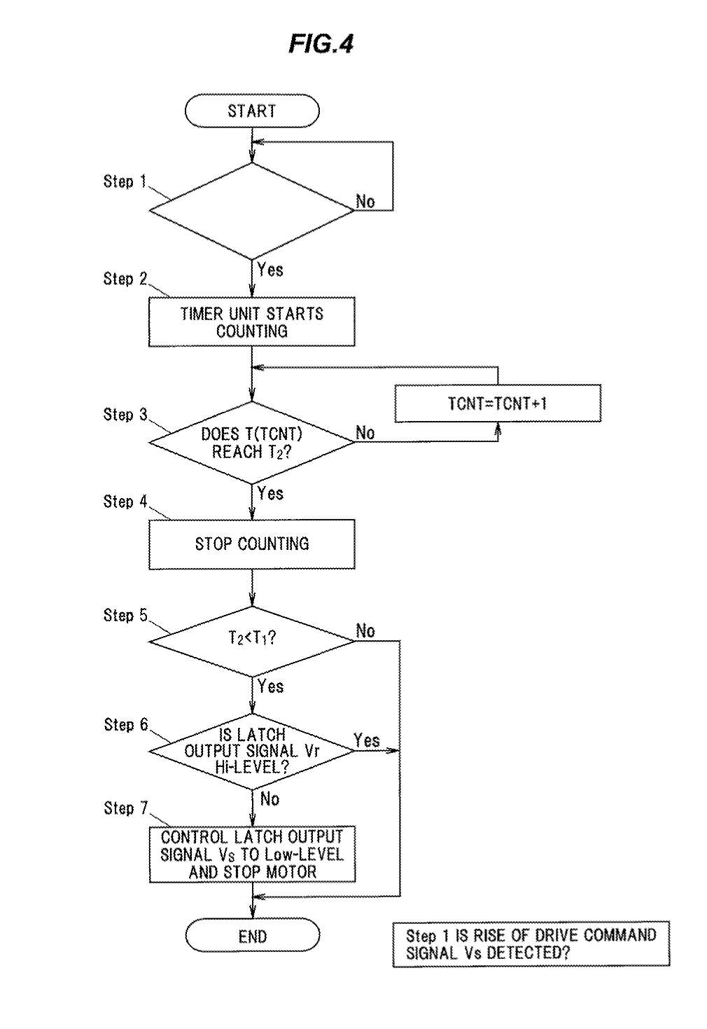

FIG. 4 is a flowchart showing an operation to detect a failure of a current feedback system in the motor drive unit. A failure detection method using the microcomputer 300 will be described below based on the flowchart.

Firstly, the microcomputer 300 determines whether or not the rise of the drive command signal Vₛ is detected (Step 1). The process proceeds to Step 2 when the rise of the drive command signal Vₛ is detected. Step 1 is repeated when the rise of the drive command signal Vₛ is not detected.

In Step 2, the timer unit 360 starts counting. The count is started in a state that an internal counter value TCNT is reset.

The timer unit 360 determines whether or not time T corresponding the counter value TCNT, i.e., T(TCNT), reaches the current feedback detection time T2 (Step 3). Step 3 is repeated after adding 1 to the counter value TCNT each time when T(TCNT) has not reached T2. The process proceeds to Step 4 when T(TCNT) reaches T2.

In Step 4, the timer unit 360 stops counting.

The microcomputer 300 determines whether or not the relation of T2<Motor drive command time T1 is satisfied (Step 5). The failure determination flow is ended when the relation is not satisfied (NO). The process proceeds to Step 6 when the relation is satisfied (YES).

The microcomputer 300 determines whether or not the latch output signal V, is inverted and becomes Hi-level (Step 6). The failure determination flow is ended in the case of YES. The process proceeds to Step 7 in the case of NO. The microcomputer 300 controls the drive command signal Vₛ to Low level and thereby stops the motor 110. In other words, the microcomputer 300 determines that the current feedback system has failed, and then stops the drive command signal Vₛ as a PWM signal at constant frequency which is then switched to Low level (Step 7). This stops the motor 110 and provides safety in the event of failure.

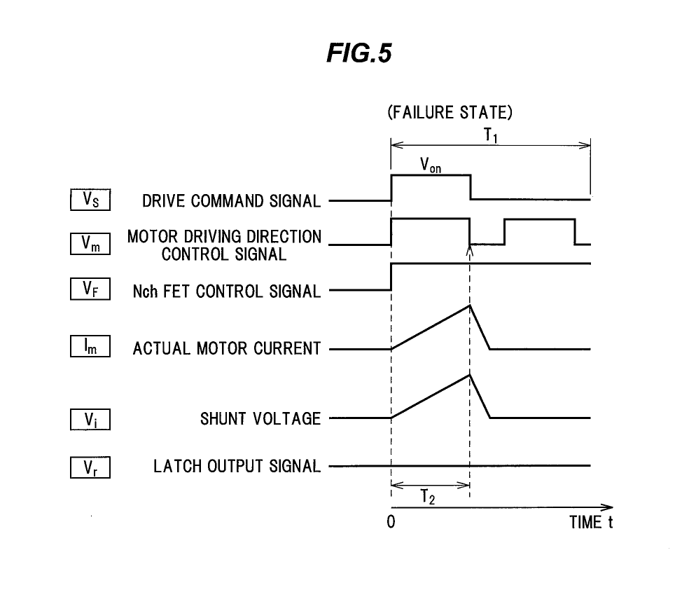

FIG. 5 is a diagram illustrating signal waveforms of respective portions when a failure occurs in the motor drive unit in the embodiment of the invention. The operation of the motor drive unit 1 when a failure occurs will be described in order of the following (1) to (5) along the waveforms at main points shown in FIG. 5.

(1) In the motor drive command time T1, the output of the drive command signal Vₛ becomes Hi-level (ON signal Vₒₙ).

(2) The driving signals V_{d1} and V_{d2} are output from the gate circuit 600 to turn on the FETs 1 and 4 and off the FETs 2 and 3.

(3) The current Iₘ flows through the motor 110 and the current detection signal Vᵢ is generated by the shunt resistor 410.

(4) A failure occurs in the current feedback system. In other words, a failure occurs in the current feedback circuit 400 or the latch circuit 500. Due to this failure, the latch output signal Vᵣ is not inverted even after the current feedback detection time T2 is elapsed.

(5) The microcomputer 300 controls the drive command signal Vₛ to Low level.

Accordingly, the driving signals V_{d1} and V_{d2} become Low level, the FETs 1 and 4 are turned off and the motor 110 stops running.
The motor 110 is stopped by the operations (1) to (5) when a failure occurs in the current feedback system.

Effects of the Embodiment

The motor drive unit 1 configured as described achieves the following effects.

(1) In the motor drive unit 1 in the embodiment of the invention, time elapsed from the rise of the drive command signal Vₛ is counted by the timer unit of the microcomputer 300, detection of the inverted output of the latch output signal Vᵣ is carried out after elapsing the current feedback detection time T2, and a failure of the current feedback system is thereby detected. As a result, it is possible to provide a motor drive unit which can detect a failure of the current feedback system using a portion of the motor drive unit per se without separately providing a failure detection circuit.

(2) An electric current flows through the motor 110 even when a failure occurs in the current feedback system (the current feedback circuit 400, the latch circuit 500). Therefore, there is a risk that an overcurrent flows through the motor 110 in the event of failure. However, it is possible to prevent the overcurrent to the motor 110 by the present embodiment.

(3) The current feedback detection time T2 can be changed depending on the operating environment such as temperature and it is possible to appropriately detect a failure by setting the optimum T2. In addition, by setting the current feedback detection time T2 to be longer than the calculated time to reach the target current (calculated current feedback), it is possible to add a failure detection function without impairing normal current control operation.

(4) It is not necessary to separately provide a failure detection circuit. Therefore, it is possible to reduce space for circuit and this allows a substrate to be downsized and space for substrate to be effectively used.

(5) The reduction in the space for circuit, the downsizing of the substrate and the effective use of space for substrate described above provide an effect of improving the product cost.

Although the embodiment of the invention has been described, the embodiment is merely an example and the invention according to claims is not to be limited thereto. Although the motor drive unit which drives a motor by controlling on/off of a current has been described above, the present embodiment is applicable not only to the motor and is also applicable as a load driving device as long as activation of the load can be controlled by controlling on/off of the current. It is applicable to electromagnetic coils and heaters, etc., as the load other than motor, as long as it can be driven by an electric current.

In addition, this new embodiment and modifications thereof may be implemented in various other forms, and various omissions, substitutions and changes, etc., can be made without departing from the gist of the invention. In addition, all combinations of the features described in the embodiment are not necessary to solve the problem of the invention. Further, the embodiment and modifications thereof are included within the scope and gist of the invention and also within the invention described in the claims and the range of equivalency.

What is claimed is:

1. A motor drive unit, comprising:
a motor drive circuit that drives a motor by controlling on/off of current;
a control unit generating a drive command signal for driving the motor;
a current feedback circuit that comprises a current detection resistor and a comparator connected in series with the motor and outputs a comparison output signal based on comparison between a current detection signal of a motor current and a target value signal;
a latch circuit that latches a current detection result based on the drive command signal and the comparison output signal; and
a gate circuit for driving the motor drive circuit based on the drive command signal and a latch output signal output from the latch circuit,
wherein the control unit detects a failure of a current feedback system comprising the current feedback circuit and the latch circuit according to a state of the latch output signal inputted after a time measured based on the drive command signal reaches a predetermined time.

2. The motor drive unit according to claim 1, wherein the predetermined time is set to be a time T2 to reach a target current to be set by the target value signal during normal operation.

3. The motor drive unit according to claim 1, wherein, when a failure is detected, the control unit changes the drive command signal to turn off the current flowing though the motor.

4. The motor drive unit according to claim 1, wherein the control unit comprises a single chip microcomputer and
wherein the time measured based on the drive command signal is measured by a timer unit built in the single chip microcomputer.

5. The motor drive unit according to claim 2, wherein the control unit determines a failure when the latch output signal is not inverted after the measured time after the measured time reaches the time T2.

6. The motor drive unit according to claim 2, wherein the control unit terminates an operation of the failure detection when the latch output signal is inverted after the measured time after the measured time reaches the time T2.

7. The motor drive unit according to claim 2, wherein the control unit outputs at least once the drive command signal in a motor drive command time T1 greater than the time T2.
